(19) United States
(12) Patent Application Publication
(10) Pub. No.: US 2006/0121157 A1
(43) Pub. Date: Jun. 8, 2006

(54) Processing of malt for preparing a beverage

(76) Inventors: Martinus Petrus Maria Caspers, Rijswijk (NL); Mei Wang, Oegstgeest (NL); Robert Jan Hamer, Amersfoort (NL)

Correspondence Address: YOUNG & THOMPSON, 745 SOUTH 23RD STREET, 2ND FLOOR, ARLINGTON, VA, 22202, US

(21) Appl. No.: 10/530,034

(22) PCT Filed: Oct. 3, 2003
(86) PCT No.: PCT/NL03/00675

§ 371 Date: Apr. 1, 2005

(30) Foreign Application Priority Data
Oct. 3, 2002 (NL) 1021576

(51) Int. Cl. C12C 11/00

(52) U.S. Cl. 426/11

(57) ABSTRACT

In a method for preparing a beverage, a dough—which has been prepared from malt flour and water=13 is diluted with water to a mixture of malt flour in water, the diluted mixture containing 11 to 45 wt. % malt flour, based on the total weight of the mixture. Also described are intermediate products and beverage obtainable by a method as described. The method has been found particularly suitable for preparing alcohol-containing beverages.

The invention relates to a method for preparing a beverage. The invention further relates to intermediate products and a beverage which are obtainable by means of a method according to the invention.

Malted cereals are used in the preparation of all types of beverages. Thus, for instance, they are used in kvass, a fermented nonalcoholic beverage. In the abstract of Russian application RU 2 177 501 it is described that a dough is prepared which contains 3-10% malt and diverse other ingredients, such as boiled potatoes, rusk crumbles, bakery yeast, rye flour, sugar, and flavorings. This mixture is diluted in a ratio of 1:12 to 1:5 and fermented.

Also for brewing alcohol-containing beverages based on cereal, such as beer, the cereal, in particular barley, is generally malted. The malt is subsequently ground to malt flour, which is then dispersed in excess water. This mixture is subsequently processed to wort, which is in turn processed to a beverage, for instance by means of fermentation.

It has been found that in such a brewing process by no means all of the polymers, such as starch, cell wall components, proteins, and sugars originating from the cereal, are decomposed. Insufficient decomposition of such components proves to be able to lead to, inter alia, turbidity and gel formation, which can, in turn, lead to product and/or time loss as a result of filtration problems during brewing. It can also adversely affect the stability and/or the quality of the final product, in particular of beer.

Through the filtration problems in conventional processes, use is therefore generally made of coarsely ground malt grits, in which relatively large pieces of chaff are still present, which serve as aid for limiting filtration problems. The use of coarsely ground malt grits, however, is not always sufficient to effectively solve the filtration problem and also has drawbacks with respect to the efficiency of the beverage preparation process.

It is an object of the invention to provide a novel method for preparing a beverage based on a cereal, in which at least one of the above-mentioned drawbacks is removed or at least reduced.

It has now been found that this object is achieved by processing malt flour in a specific manner.

The invention therefore relates to a method for preparing a beverage in which a dough is prepared from malt flour and water and the dough is then diluted with water to a mixture, in particular a dispersion, of malt flour in water.

The mixture can be further processed in a manner conventional for the beverage preparation, for instance beer preparation. Among typical processing steps of which one or more can be carried out are filtering, extracting, heating, cooling, adding additives, and fermenting.

The term water is used herein in a general sense. This term particularly comprises distilled water, demineralized water, mains water, and in general aqueous solutions suitable for use in consumption goods, in particular beer and other beverages.

Malt flour is a flour which, at least to a substantial part, consists of ground, completely and/or partly germinated cereal. Besides, the malt flour may optionally contain ground, non-germinated cereal.

The dough is a kneadable mixture, which substantially contains malt flour and water. The malt flour is preferably finely ground malt flour, so that no relatively large pieces of chaff are present in the flour.

Optionally, the flour may first be separated by a sieving process (for instance by means of a sieve having a mesh in the range of 112-1000 μm, preferably a mesh in the range of 112-475 μm) into a coarse part (for instance with at least substantially particles having a particle size of more than 1000 μm, or of more than >475 μm) and a fine part. The fine part preferably consists at least substantially of parts having a particle size of less than 1000 μm, very preferably of less than 475 μm, particularly preferably of less than 112 μm.

The fine part is preferably used for preparing dough having improved consistency.

If desired, the coarse part may be added again to the dough or diluted mixture at a later stage with a view to a good natural filtration effect of malt grits. It is observed that the dough compositions mentioned lower down preferably relate to the situations in which no coarse parts have been added.

One or more additives licensed for foodstuffs may be added as well, for instance one or more additives which favorably affect the consistency of the dough, such as, for instance, common salt (NaCi). Common salt is preferably present in the dough in a concentration of 0-3 wt. % (based on the total weight of dry flour), in particular in a concentration of 0.025-2 wt. % (based on the total weight of dry flour).

The dough preferably has a consistency of at least 100 Brabender Farinograph units, more preferably at least 150 Brabender Farinograph units. Particularly good results have been achieved with a dough having a consistency of at least 300 Brabender Farinograph units. The Brabender Farinograph units as meant herein are the values obtainable by means of measurement on a Farinograph® E, by means of ISO 5530-1.

The content of malt flour and water may vary depending on the use, other ingredients and the type of malt flour. On the basis of general expert knowledge and of what is described herein, the skilled worker will know to select a suitable ratio of constituents to achieve a good consistency. In practice, the dough will usually consist to at least 45 wt. % of malt flour. Very good results have been achieved with a malt flour content of at least 50 wt. % malt flour, in particular approximately 55-65 wt. % of malt flour.

With respect to the amount of water very good results have been achieved with a water content of maximally 45 wt. %, in particular with a water content in the range of 35-44 wt. %.

The weight percents (wt. %) herein relate to the total weight of the respective composition, unless explicitly mentioned otherwise.

It has been found that by means of a method according to the invention a more effective conversion of starch to sugars takes place, and in particular to fermentable sugars. A method according to the invention can also contribute to a better decomposition of other constituents of the malt flour, for instance of proteins. Since the sugar content directly relates to the yield of alcohol when the mixture is fermented, the invention offers the possibility of generating a higher yield of an alcohol-containing beverage, such as beer.

A method according to the invention has the economic and environmental advantages that no excess water need be used, which can also result in time and energy saving because no excess water, therefore, need be heated, cooled and/or removed.

Besides, a method according to the invention offers the advantage that no or at least fewer clogging problems occur during the further processing of the diluted mixture of malt flour in water and/or of wort and/or beverage (in particular beer) which have been prepared from the mixture. In particular, clogging of filters and the like can be prevented or can at least be reduced. It is assumed that as a result of the increased conversion of starch to sugars undesired gel formation of the above-mentioned polymers, such as starch and/or proteins, in the diluted mixture, the wort and/or the beverage is reduced or even completely prevented. Such gels can actually lead to clogging of filters.

Through the good filtration characteristics, it is possible to process the malt flour in an economically attractive manner and to prepare a beverage without making use of chaff as filtering aid, even though it is possible, in principle, to use chaff as such in a method according to the invention. The chaff content in the malt flour and the diluted mixture (dispersion) may therefore be low, which can, for instance, offer advantages with respect to the taste and stability.

An additional advantage of a method according to the invention is that because of the favorable effects on the filtration characteristics it is now possible to prepare a more concentrated mixture (dispersion) and, in particular, a more concentrated wort than hitherto usable for further processing to beverage. Thus, for instance, in the beer preparation it is conventional to use wort having a content of 10-20 wt. % of malt flour constituents. The invention renders it possible to favorably use wort having a content of more than 20 to 40 wt. % or more of malt flour constituents. As a result thereof, the yield of final product (such as beer) can be considerably increased.

A particular aspect of the invention further is that use can efficiently be made of finely ground malt flour, starting from flour bodies or malt grits, the chaff, if present, having been finely ground as well. The use of finely ground malt flour is desired because a higher yield of final pro ducts can thus be obtained.

In principle, the invention can be applied to any type of malt flour. Very suitable is barley malt flour, even though other malt flours are also suitable.

An additional advantage of the invention is that the quality of the raw material for the malt flour is less critical to obtaining a good yield and quality of the final product. Thus, for instance, the invention offers the possibility of effectively and economically attractively making use of malt flour prepared which has been prepared from cereal consisting to a substantial part of, for instance mainly, of glassy grains (so-called “stealy” cereal), non-germinated grains, incompletely germinated grains and/or grains of traditional “non-malt” barley or other cereals which do not (completely) meet the requirements for the traditional specific brewing barley. In respect of, for instance, cereal which was previously found unsuitable for brewing a beverage, such as beer, because it did not meet the traditionally required specifications (as laid down in, for instance, the EBC (European Brewing Convention) standards) in the field of protein content, extract yield, kolbach, friability, germ capacity, yeastability etc. it has been found that by means of the invention it is usable for brewing a beverage, such as beer.

When malt flour, and in particular malt flour of relatively low quality, is processed in a conventional method (by adding excess water), it generally turns out that the starch is decomposed only in a relatively small degree. By first kneading the malt flour to a dough, the starch proves to be able to be decomposed in a greater degree. It is assumed that kneading leads to breaking a protective layer which protects the starch bodies in the flour from factors promoting starch decomposition, such as specific enzymes. Thus, for instance, it could be so that the starch is protected by a protein matrix which has deposited on the flour bodies during the formation of the seed. Besides, in particular for glassy grains, the low water uptake capacity could adversely affect the decomposition of starch. Moreover, it is not impossible that through modifications in the molecular structure of the starch hydrolases show less activity for the starch in glassy grains.

Previous to the dilution with water, the dough is preferably kneaded for some time. The kneading temperature, kneading time, and the kneading power may be selected within broad limits. The skilled worker will know to determine a suitable temperature, time and power on the basis of the desired degree of conversion of starch and the nature of the malt flour.

Very suitable is a method in which the dough is kneaded for at least min or mechanical energy is supplied to the dough in another manner. The upper limit is not particularly critical and may, for instance, be two or more hours. In practice, a shorter kneading time will already be sufficient to obtain a favorable effect. Very good results have, for instance, been achieved with a kneading time of 30-45 min.

The supplied mechanical energy, such as the kneading energy supplied during kneading, is preferably at least 1 kJ/kg/min dough. The upper limit is not particularly critical. Very good results have, for instance, been achieved with a mechanical energy (in particular kneading energy) in the range of 1 to 100 kJ/kg/min.

By kneading, not only the dough components are mixed to a homogeneous mass, but it is further assumed that, by kneading, polymer constituents, such as proteins, starch, and cell walls, are better and more rapidly accessible to decomposition by enzymes and that, accordingly, the undesired gel formation already mentioned above can be reduced or even prevented, in particular such gel formation caused by cell wall components, such as glucanes and pentosanes. Moreover, proteins and starch can be more rapidly hydrated. Besides, it has been found that kneading has a favorable effect on the decomposition of protein structures, such that backformation of the protein structure can be prevented.

It is assumed that decomposition of the macromolecular protein structures is favorable for the efficiency of the modification of the malt. Kneading may, for instance, very suitably be carried out in a mixer, in particular a mechanical mixer, for instance in a Z-blade mixer, a pin mixer, an extruder or an ultrasonic apparatus.

Besides by kneading, it is possible, in principle, to differently supply energy to the dough, for instance through a heat treatment. Particularly considered here is a heat treatment at a temperature of approximately 25-60° C., preferably for a time sufficiently long to supply the above-mentioned inserted energy to the dough. The skilled worker will know to determine a suitable period of time by way of routine, depending on factors such as the temperature, the batch size, and the heat capacity of the dough.

In practice, it is preferred to carry out the supply of mechanical energy (as by kneading) and/or the dilution at a temperature of 15-60° C. Preferably, the temperature is lower than 50° C. At a temperature within the range of 20-45° C., it has been found that a very good decomposition of compounds and/or structures which adversely affect the filtration takes place. Very good results have been achieved at a temperature of approximately 25-35° C., for instance circa 30° C.

After supplying the energy (as by kneading), the dough is diluted with water. The dilution with water may occur by adding water to the dough or by adding dough to the water. The water is preferably gradually admixed with the dough while substantially continuously mixing (for instance kneading and/or stirring) so that the formation of an insoluble dough ball in water is prevented. Preferably immediately after kneading, the dough is further diluted with water until the desired consistency for the intended use has been obtained, for instance until a consistency conventional for wort.

Preferably, the dilution is carried out until a content in the range of 11 to 45 wt. % malt flour constituents based on the total weight of the mixture. Very preferably, the content of malt flour constituents is more than 20 wt. % and less than 40 wt. %.

A method according to the invention is particularly suitable for preparing a fermented beverage, in particular beer. The further steps of processing the diluted mixture (dispersion) of malt flour in water may be carried out in a manner known in the state of the art. The diluted mixture may, for instance, be processed to wort and then be fermented. Previous to the fermentation, one or more steps conventional for the preparation of beverage may optionally be carried out, such as extracting, filtering, diluting, adding hops, boiling wort, etc.

The invention also relates to a dough obtainable by means of the invention and to a dough which at least substantially consists of a kneadable mixture of malt flour and water. Preferably, the ratios of malt flour to water, the consistency of the dough and/or the presence of additives are as defined above.

In principle, any cereal type is suitable to serve as raw material for a dough according to the invention. Preferably, the dough is based on malt flour of wheat and/or barley, more preferably barley malt flour is one of the ingredients in the dough.

The invention further relates to a mixture, in particular a dispersion, of malt in water, which mixture is obtainable by means of a method according to the invention.

The invention also relates to a beverage, in particular beer, which is obtainable by means of a method according to the invention.

1. A method for preparing a beverage, wherein a dough—which has been prepared from malt flour and water—is kneaded and thereafter diluted with water to a mixture of malt flour in water, the diluted mixture containing 11 to 45 wt. % malt flour, based on the total weight of the mixture.

2. A method according to claim 1, wherein the mixture of malt flour in water is filtered and/or extracted.

3. A method according to claim 1, wherein the dough has a consistency of at least 100 Brabender Farinograph units.

4. A method according to claim 1, wherein the dough is kneaded for at least 15 min, preferably 30-45 min.

5. A method according to claim 1, wherein the kneading energy supplied during kneading is at least 1 kJ/kg malt flour.

6. A method according to claim 1, wherein the dough is kneaded until the supplied energy is 10-100 kJ/kg malt flour.

7. A method according to claim 1, wherein the dough is kneaded at a temperature of 15-50° C., preferably of 20-45° C.

8. A method according to any one of the preceding claims claim 1, wherein the malt flour comprises barley malt flour, wheat malt flour or a combination thereof.

9. A method according to claim 8, wherein the malt flour has been prepared from an amount of barley which substantially consists of glassy grains, non-germinated grains and/or incompletely germinated grains.

10. A method according to claim 1, wherein the beverage is a fermented beverage, preferably beer.

11-15. (canceled)

16. A method according to claim 2, wherein the dough has a consistency of at least 100 Brabender Farinograph units.

17. A method according to claim 2, wherein the dough is kneaded for at least 15 min, preferably 30-45 min.

18. A method according to claim 3, wherein the dough is kneaded for at least 15 min, preferably 30-45 min.

19. A method according to claim 2, wherein the kneading energy supplied during kneading is at least 1 kJ/kg malt flour.

20. A method according to claim 3, wherein the kneading energy supplied during kneading is at least 1 kJ/kg malt flour.

21. A method according to claim 4, wherein the kneading energy supplied during kneading is at least 1 kJ/kg malt flour.

22. A method according to claim 2, wherein the dough is kneaded until the supplied energy is 10-100 kJ/kg malt flour.

23. A method according to claim 3, wherein the dough is kneaded until the supplied energy is 10-100 kJ/kg malt flour.

24. A method according to claim 4, wherein the dough is kneaded until the supplied energy is 10-100 kJ/kg malt flour.

25. A method according to claim 5, wherein the dough is kneaded until the supplied energy is 10-100 kJ/kg malt flour.
